(19) United States
(12) Patent Application Publication
(10) Pub. No.: US 2018/0334578 A1
(43) Pub. Date: Nov. 22, 2018

(54) Thermo-Shielding Window Coating Composition and Method

(71) Applicants: Universiti Brunei Darussalam, Gadong (BN); PIXELA CORPORATION, Osaka (JP)

(72) Inventors: Toru Kitamura, Izumiotsu, Osaka-fu (JP); Atiqah Md Ali, Kpg Tanah Jambu. Jalan Muara, Muara (BN); Nur Fajrini binti Matjalina, Kampong Kapok, Muara (BN); Haji Mohammad Redza bin Haji Hussin, STKRJ Kampong Lambak Kiri, Berakas (BN)

(73) Assignee: PIXELA CORPORATION, OSAKA (JP)

(21) Appl. No.: 15/504,612

(22) PCT Filed: Mar. 31, 2016
(86) PCT No.: PCT/IB2016/051853

§ 371 Date: Feb. 16, 2017

(30) Foreign Application Priority Data
Feb. 9, 2016 (BN) BN/N/2016/0017

(51) Int. Cl. C09D 5/32; C03C 17/32; C09D 7/63; C09D 7/20; C09D 7/61; C09D 7/40; C09D 127/22

(52) U.S. Cl. CPC C09D 5/32; C03C 17/32; C09D 7/63; C09D 127/22; C09D 7/61; C09D 7/67; C09D 7/20

(57) ABSTRACT

The present invention is related to a thermo-shielding window coating composition having improved thermo-shielding and weathering resistant properties when applied to glass surfaces. The composition is made by first mixing an infrared absorbing pigment in amount of up to 5 wt. % with first dosage of an aqueous or alcoholic sulfonate group grafted fluoropolymer resin in amount of up to 10 wt. %, and water in amount of up to 10 wt. % to obtain a mixer, then dispersing the mixer by a disperser, and simultaneously adding second dosage of the sulfonate group grafted fluoropolymer resin in amount up to 90 wt. % to the above mixer until homogenous solution is obtained, wherein the weight % is calculated based on the total weight of the coating composition.

### CROSS REFERENCE TO RELATED APPLICATIONS

The instant application claims priority to Brunei patent application BN/N/2016/0017 filed on Feb. 9, 2016 and International Application PCT/IB2016/051853 filed Mar. 31, 2016. The pending Brunei patent application BN/N/2016/0017 and PCT/IB2016/051853 are hereby incorporated by reference in its entireties for all of its teachings.

### FIELD OF THE INVENTION

The present invention is generally related to thermo-shielding window coating composition having improved thermo-shielding and weathering resistant properties when applied to glass surfaces. The invention is more specifically an aqueous fluoropolymer based window coating liquid that can be used to apply infrared absorbing coating on transparent window panes of windows, and on glasses used in buildings, vehicles.

### BACKGROUND OF THE INVENTION

Electromagnetic radiation comprises of three components i.e. infrared radiation (IR), visible light, and ultraviolet radiation (UVR). Heat is caused due to infrared radiation (IR) which is invisible radiant energy with longer wavelengths than those of the visible light having wavelength from 700 nm to 1 mm. Much of the thermal radiation emitted by objects near room temperature is infrared (IR) rays. Approximately half of the solar energy emitted from the sun caused by infrared rays. It is therefore required that materials capable of adsorbing or blocking infrared rays could be used as thermos-shielding composition to prevent temperature rise in a room, in a car for housing, and car windows during the summer season.

There are several products in the market that have the similar thermo-shielding or infra-red (IR) absorbing or blocking capability. Such products contains one or more infrared absorbing ingredients in the weathering resistant resin.

US20150079403A1 discloses an aqueous coating composition including a hydroxy-functional fluoropolymer. The aqueous coating composition is formulated and applied directly to a substrate, such as glass, without any need of surface treatment. The coating composition contains at least one hydroxyfunctional fluoropolymer, at least one polyisocyanate. The fluoropolymer can be polyvinyl fluoride chlorotetrafluoroethylene, polytetrafluroethylene, fluorinated polyethylene vinyl ether, and fluorinated ethylene vinyl ester. Further, the aqueous coating composition may also include pigment.

US2015086792 discloses a heat-ray-shielding sheet that is applicable to windows of buildings, windows of vehicles, window glasses for refrigerator. The heat-ray-sheilding sheet may also include near-IR absorbing dye, microparticles, thermoplastic resin. Further, the thermoplastic resin can be a polytetrafluoroethylene resin, a tetrafluoroethylene-hexafluoropropylene copolymer resin, a tetrafluoroethylene-perfluoroalkyl vinyl ether copolymer resin, an ethylene tetrafluoride-ethylene copolymer resin, a polytrifluorochloroethylene resin, a polyvinylidene fluoride resin. The average molecular weight of the thermoplastic resin can be in the range of about 2,000 to 200,000. The microparticles can be ITO or ultra-fine ITO particles and the microparticles may have an average particle diameter of equal to or less than 100 nm. The near IR-absorbing dye can be porphyrazine or its derivatives.

CN104327626A describes a hydrolysis and light resistant aqueous coating for glass doors. The coating is prepared by using the raw materials. The raw materials may also include PVDF fluorocarbon resin, tin oxide, pigments.

U.S. Pat. No. 8,221,657B2 explains a composition of novel phthalocyanines and thermoplastic or cross linkable polymers and an architectural or automotive glazing containing these phthalocyanines. The thermoplastic or cross linkable polymers can be polyvinylidene fluoride.

However, several drawbacks still prevailing in the existing products. The drawbacks which have been identified includes: dispersion of strong smell caused by organic solvents used for forming a uniform thin film or layer on a flat and transparent glass surface; difficulty in removing coating for reapply, fragility to the long span UV radiation of the strong sun light UV.

The present invention solves the aforementioned drawbacks of the art while keeping its thermo-shielding and weathering resistant function better than conventional products. The present invention provides an aqueous solution comprising fluoropolymer resin, water, and infrared absorbing pigments. The fluoropolymer is modified by incorporating a sulfonic group to obtain sulfonic group grafted fluoropolymer with an average molecular weight up to 2,000,000.

### OBJECT OF THE INVENTION

Accordingly, one object of the present invention is to provide an aqueous fluoropolymer based formulation for coating glass window panes.

One more object of the present invention is to provide a sulfonate group grafted fluoropolymer resin based liquid for coating applications of glasses used in windows of houses, buildings, and automobiles.

Another object of the present invention is to provide a composition having thermo-shielding or infra-red (IR) absorbing capability when it is applied on glass surface.

Yet another object of the present invention is to provide an easily applicable window coating composition having improved thermo-shielding and weathering resistant properties.

Yet another object of the present invention is to provide a process of making a sulfonate group grafted fluoropolymer resin based aqueous formulation with improved IR absorbing functionality.

Still another object of the present invention is to produce a coating liquid comprising water, infra-red absorbing additives, and a sulfonate group grafted fluoropolymer for forming a smell free and uniform thin film on a flat and transparent glass surface.

Still further object of the present invention is to provide an easily removable coating liquid that can be removed from a transparent glass after a bad spraying outcome that the worker needs to reapply the coating again on the transparent glass.

One further object of the present invention is obtain an aqueous fluoropolymer coating composition for direct application to glass without the need for pre-treatment of the glass surface.

One further object of the present invention is to obtain a coating formulation having excellent wet adhesion to glass, easily removable properties, easily applicability on to glass surface, transparency, improved weathering resistance, and infra-red absorbing capability.

One related object of the present invention is to develop a thermo-shielding window coating formulation for applications like windows of buildings, windows of vehicles, window glasses and the like.

Other objects and advantages of the present invention will be more apparent from the following description which is not intended to limit the scope of the present invention.

### SUMMARY OF THE INVENTION

In one aspect of the present invention, a coating composition for glass surface is provided. The composition contains a sulfonic group grafted fluoropolymer, an aqueous solvent preferably water; and at least one infrared rays absorbing pigment having mean primary diameter equal or less than 100 nm. The coating composition further comprises a silane coupling agent to improve water resistance and adhesion.

In one another aspect of the present invention, there is provided a coating composition for glass windows forming part of houses, buildings, automobiles and the like. The composition comprises a sulfonate group grafted fluoropolymer resin having average molecular weight from 20,000 to 2,000,000, at least one infrared absorbing pigment having mean primary diameter up to 100 nm, wherein the pigment is at least one selected from the group consisting of phthalocyanine blue, phthalocyanine green, carbon black, titanium black, indium doped tin oxide, and antimony doped tin oxide.

In one embodiment, the fluoropolymer used in the formation of the present composition is at least one selected from the group consisting of polyvinyl fluoride (PVF), chlorotetrafluoroethylene (CTFE), polytetrafluroethylene (PTFE), fluorinated polyethylene vinyl ether, fluorinated ethylene vinyl ester (FEVE), and poly vinylidene fluoride (PVdF).

In one embodiment of the present invention, the infrared absorbing pigment can be selected from the group consisting of but not limited to organic, inorganic, or ceramic material.

In one embodiment of the present invention, the infrared absorbing pigment used in the method of the present invention can be selected from the group consisting of phthalocyanine blue, phthalocyanine green, carbon black, titanium black, indium doped tin oxide, and antimony doped tin oxide.

In yet another aspect of the present invention a process of making coating composition for glass windows is disclosed. The process comprising, first mixing at least one infrared absorbing pigment in amount of up to 5 wt. % with first dosage of an aqueous or alcoholic sulfonate group grafted fluoropolymer resin in amount of up to 10 wt. %, and water in amount of up to 10 wt. % to obtain a mixer, then dispersing the mixer by a disperser, and simultaneously adding second dosage of the sulfonate group grafted fluoropolymer resin in amount up to 90 wt. % to the above mixer until homogenous solution is obtained, wherein the weight % is calculated based on the total weight of the coating composition.

In further aspect of the present invention, a process is provided for adhering an aqueous sulfonate grated fluoropolymer coating composition to a transparent glass surface, having at least one infrared rays absorbing pigment, applying said coating composition to the glass surface. In one embodiment, the coating composition further comprises a silane coupling agent to improve water resistance and adhesion.

These and other features, aspects, and advantages of the present subject matter will become better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### DETAILED DESCRIPTION OF DRAWINGS

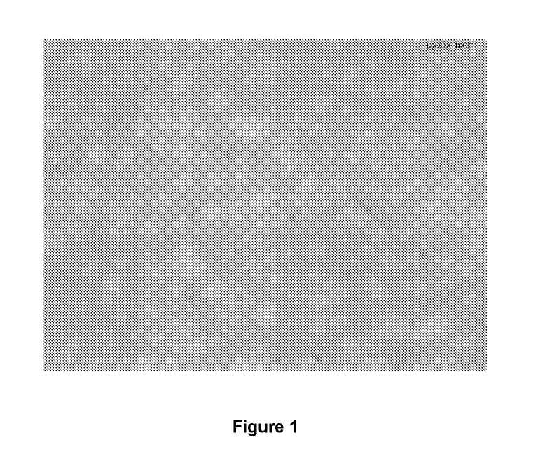

FIG. 1 is a view of highly dispersed colored pigment in an aqueous polymer.

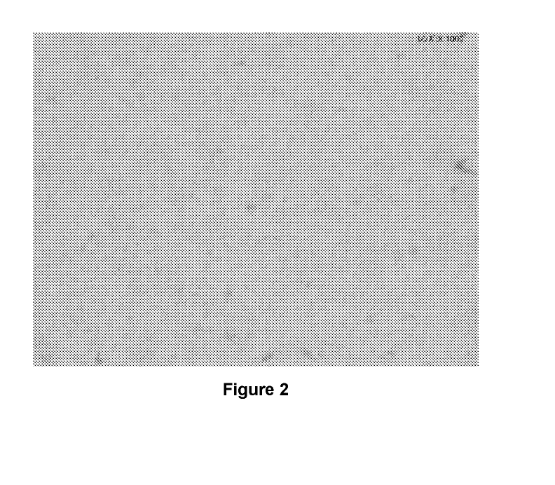

FIG. 2 is view of poorly dispersed colored pigment in an aqueous polymer.

### DETAILED DESCRIPTION

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a”, “an” and “the” are used to refer to one or to more than one (i.e., to at least one) of the grammatical object of the article.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to.” “Including” and “including but not limited to” are used interchangeably.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

In one aspect of the present invention, a coating composition disclosed herein can be used for forming a thin layer of the composition on glass surface of windows of houses, buildings, automobiles, or on glasses used in residential or commercial buildings. The coating composition is an aqueous fluoropolymer based formulation which is obtained by mixing water, at least one infrared absorbing pigment, and a modified fluoropolymer. The fluoropolymer can be modified by incorporating sulfonic group in an aliphatic or aromatic fluoropolymer through esterification or polymerization process which are well known in the art. In one embodiment, the modified fluoropolymer is a sulfonate group grafted fluoropolymer. The coating composition made from the process of the present invention can easily be applied, removed, and reapplied to a glass surface of windows of automobile, windows of buildings, structures that installs such windows, and windows having glass panes. The coating composition has improved thermo-shielding and infrared absorbing functionality over the conventional coating which can be easily applied to either side of glass windows.

In another aspect of the present invention, provided herein is a thermo-shielding window coating solution that can be applied directly or indirectly to a glass surface. The coating solution used to coat glass windows comprising a sulfonate group grafted fluoropolymer resin having an average molecular weight up to 2,000,000, and at least one infrared absorbing pigment having mean primary diameter up to 100 nm, and water to minimize viscosity of fluoropolymer.

In yet another aspect, a process of making a coating composition for glass windows is provided. The composition is made by first mixing at least one infrared absorbing pigment in amount of up to about 5 wt. % with first dosage of an aqueous or alcoholic sulfonate group grafted fluoropolymer resin in amount of up to about 10 wt. %, and water in amount of up to about 10 wt. % to obtain a mixer, then the mixer is dispersed by a disperser. The dispersed mixer obtained so far is further mixed with the second dosage of aqueous or alcoholic sulfonate group grafted fluoropolymer in an amount up to about 90 wt. % until a homogenous solution is obtained. The weight % above is calculated based on the total weight of the coating composition.

In one aspect of the present invention, about 1 wt. % of a 100% solid blue pigment is used as an infrared absorbing pigment. In some embodiments, the infrared absorbing pigment is at least one selected from the group consisting of but not limited to phthalocyanine blue, phthalocyanine green, carbon black, titanium black, indium doped tin oxide, and antimony doped tin oxide.

In one aspect of the present invention, the sulfonate group grafted fluoropolymer resin used in the process of the present invention selected from the group consisting of but not limited to polyvinyl fluoride (PVF), chlorotetrafluoroethylene (CTFE), polytetrafluroethylene (PTFE), fluorinated polyethylene vinyl ether, fluorinated ethylene vinyl ester (FEVE), and poly vinylidene fluoride (PVdF). In one embodiment, the fluoropolymer is sulfonic grafted polytetrafluroethylene (PTFE), or Sulfonic grafted poly vinylidene fluoride (PVdF). The sulfonate grafted polymer used in the present invention is a Nafion505 which is produced by copolymerization of a flurosulfonylated trifluroenol ether with tetra-fluroethylene then hydrolysis of the sulfonic acid or can be made by other methods known in the art.

The polytetrafluroethylene (PTFE) used in the present process is modified to incorporate sulfonic group to obtain sulfonic group grafted polytetrafluroethylene. The polytetrafluroethylene (PTFE) can be modified by process or methods well known to a person skilled in the art.

The first dosage comprising the aqueous or alcoholic sulfonate group grafted fluoropolymer resin may be used in various amounts. In some embodiments, the first dosage of the fluoropolymer resin is added in an amount ranging from about 1% to about 20% by weight of the total weight of the homogenous solution. This includes embodiments in which the amount ranges from about 1% to about 5%, from about 5% to about 10%, from about 10% to about 15%, from about 15% to about 20%, from about 5% to about 15%, from about 5% to about 20% and from about 60% to about 75% of the total weight of the homogenous solution, and ranges between any two of these values or less than any one of these values. In some embodiments, the first dosage of sulfonate group grafted fluoropolymer resin may constitute from about 1 wt. %, about 5 wt. %, about 10 wt. %, about 15 wt. %, about 20 wt. %, about 25 wt. %, and ranges between any two of these values or less than any one of these values. However, other amounts are possible. The particular amount depends upon the desired properties of the coating composition. In some embodiments, the sulfonate group grafted fluoropolymer resin includes about 5 wt. % of the homogenous solution.

The water used to form the above homogenous solution of sulfonate grafted fluoropolymer added in various amounts. In some embodiments, the water is added in an amount ranging from about 1% to about 20% by weight of the total weight of the homogenous solution. This includes embodiments in which the amount ranges from about 1% to about 5%, from about 5% to about 10%, from about 10% to about 15%, from about 15% to about 20%, from about 5% to about 15%, from about 5% to about 20% and from about 60% to about 75% of the total weight of the homogenous solution, and ranges between any two of these values or less than any one of these values. In some embodiments, the water may constitute from about 1 wt. %, about 5 wt. %, about 10 wt. %, about 15 wt. %, about 20 wt. %, about 25 wt. %, and ranges between any two of these values or less than any one of these values. However, other amounts are possible. The particular amount depends upon the desired properties of the coating composition. In some embodiments, the water includes about 5 wt. % of the homogenous solution.

The second dosage of the aqueous or alcoholic sulfonate group grafted fluoropolymer resin may be added to the dispersed mixer at various amounts. In some embodiments, the second dosage of the fluoropolymer resin is added in an amount ranging from about 1% to about 90% by weight of the total weight of the homogenous solution. This includes embodiments in which the amount ranges from about 10% to about 80%, from about 15% to about 70%, from about 20% to about 60%, from about 25% to about 50%, from about 30% to about 90%, from about 40% to about 85% and from about 50% to about 80% of the total weight of the homogenous solution, and ranges between any two of these values or less than any one of these values. In some embodiments, the second dosage of sulfonate group grafted fluoropolymer resin may constitute from about 5 wt. %, about 15 wt. %, about 20 wt. %, about 25 wt. %, about 30 wt. %, about 40 wt. %, about 65 wt. %, about 70 wt. %, about 80 wt. %, about 90 wt. %, and ranges between any two of these values or less than any one of these values. However, other amounts are possible. The particular amount depends upon the desired properties of the coating composition. In some embodiments, the second dosage of the sulfonate group grafted fluoropolymer resin includes about 90 wt. % of the homogenous solution.

The sulfonate group grafted fluoropolymer used in the above process comprises 5% aqueous solution of the sulfonate group grafted fluoropolymer. In some embodiments the sulfonate group grafted fluoropolymer used in the above process comprises 5% alcoholic solution of the sulfonate group grafted fluoropolymer.

Polytetrafluoroethylene does not flow easily above its crystalline melting point and viscosity of polytetrafluoroethylene is very high due to restricted rotation about the chain bonds and high molecular weight. In one embodiment water is used to minimize the viscosity of the modified polytetrafluoroethylene polymer being used in the formation of the aqueous fluoropolymer.

In some embodiments, average molecular weight of the sulfonate grafted fluoropolymer used in the above process can be selected in the range from about 20,000 to about 2,000,000. This includes embodiments in which the average molecular weight ranges from about 20,000 to about 1,000,000, from about 50,000 to about 1,500,000, from about 1, 00,000 to about 1,000,000, from about 5, 00,000 to about 2,000,000, from 8,00,000 to about 1,500,000. In some embodiments, the average molecular weight may be from about 20,000, about 50,000, about 1,00,000, about 2,00,000, about 5,00,000, about 8,00,000, about 1,000,000, about 1,500,000, about 1,800,000, about 2,000,000, and ranges between any two of these values or less than any one of these values. However, other amounts are possible. The particular amount depends upon the desired properties of the coating composition.

The infrared absorbing pigment used in the process of the present invention has mean primary diameter from up to 100 nm. In some embodiments, the mean primary diameter of the pigment is selected in a range from about 1 nm to about 90 nm. This includes embodiments in which the mean diameter ranges from about 1 nm to about 85 nm, from about 5 nm to about 80 nm, from about 10 nm to about 70 nm, from about 20 nm to about 60 nm, from about 30 nm to about 55 nm, from about 25 nm to about 45 nm and from about 50 nm to about 70 nm and ranges between any two of these values or less than any one of these values. In some embodiments, the mean primary diameter may constitute from about 5 nm, about 15 nm, about 25 nm, about 30 nm, about 45 nm, about 60 nm, about 70 nm, and ranges between any two of these values or less than any one of these values. However, other ranges are possible. The particular diameter value depends upon the desired properties of the coating composition. In a preferred embodiment, the mean diameter of the pigment is from about 5 nm to 70 nm.

FIG. 1 illustrates a highly dispersed colored pigment and FIG. 2 exhibits a picture of poorly dispersed colored pigment. Highly dispersion mean diameter of secondary particle of pigment should be less than 0.7 micro meter. Poorly dispersion means that mean diameter of secondary may be more than 1000 nano meter.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

I/We claim:

1. A coating composition for glass surface comprising:
an aqueous or alcoholic solution of sulfonic group grafted fluoropolymer; an aqueous solvent; and
at least one infrared rays absorbing pigment having mean primary diameter up to 100 nm.

2. The coating composition as claimed in claim 1 further comprises a silane coupling agent to improve water resistance and adhesion.

3. The coating composition as claimed in claim 1, wherein the fluoropolymer is at least one selected from the group consisting of polyvinyl fluoride (PVF), chlorotetrafluoroethylene (CTFE), polytetrafluroethylene (PTFE), fluorinated polyethylene vinyl ether, fluorinated ethylene vinyl ester (FEVE), and polyvinylidene fluoride (PVDF).

4. The coating composition as claimed in claim 3, wherein the fluoropolymer comprises sulfonic grafted polytetrafluroethylene (PTFE), or Sulfonic grafted poly vinylidene fluoride (PVDF).

5. The coating composition as claimed in claim 1, wherein the fluoropolymer comprises up to about 95 weight % of the coating composition.

6. The coating composition as claimed in claim 1, wherein the aqueous solvent comprises up to about 10 weight % of the coating composition.

7. The coating composition as claimed in claim 1, wherein the fluoropolymer has average molecular weight from 20,000 to 2,000,000.

8. The coating composition as claimed in claim 1, wherein the aqueous solvent comprising water.

9. The coating composition as claimed in claim 1, wherein the infrared absorbing pigment is selected from the group consisting of organic, inorganic, and ceramic material.

10. The coating composition as claimed in claim 9, wherein the infrared absorbing pigment comprises up to 1 weight % of the solid colored pigment.

11. The coating composition as claimed in claim 9, wherein the infrared absorbing pigment is at least one selected from the group consisting of phthalocyanine blue, phthalocyanine green, carbon black, titanium black, indium doped tin oxide, and antimony doped tin oxide.

12. The coating composition as claimed in claim 9, wherein the infrared absorbing pigment has mean primary diameter from 5 nm to 70 nm.

13. The coating composition as claimed in claim 1, wherein the solution comprises 5% aqueous or alcoholic solution of sulfonic group grafted fluoropolymer.

14. A process of making a coating composition for glass windows comprising steps of:
mixing at least one infrared absorbing pigment in amount of up to 5 wt. % with first dosage of an aqueous or alcoholic sulfonate group grafted fluoropolymer resin in amount of up to 10 wt. %, and water in amount of up to 10 wt. % to obtain a mixer;
dispersing the mixer by a disperser; and
simultaneously adding second dosage of the sulfonate group grafted fluoropolymer resin in amount up to 90 wt. % to the above mixer until homogenous solution is obtained, wherein the weight % is calculated based on the total weight of the coating composition.

15. The process as claimed in claim 14, wherein the infrared absorbing pigment is at least one selected from the group consisting of phthalocyanine blue, phthalocyanine green, carbon black, titanium black, indium doped tin oxide, and antimony doped tin oxide.

16. The process as claimed in claim 15, wherein the infrared absorbing pigment has mean primary diameter from 5 nm to 70 nm.

17. The process as claimed in claim 14, wherein the fluoropolymer comprises sulfonic grafted polytetrafluroethylene (PTFE), or Sulfonic grafted polyvinylidene fluoride (PVDF).

18. The process as claimed in claim 14, wherein the fluoropolymer has average molecular weight from 20,000 to 2,000,000.

19. A coating composition for glass windows comprising:
up to 95 weight % of sulfonate group grafted fluoropolymer resin having average molecular weight from 20,000 to 2,000,000; and
up to 1 weight % of at least one infrared absorbing pigment having mean primary diameter from 5 nm to 100 nm, wherein the pigment is 100% solid and at least one selected from the group consisting of phthalocyanine blue, phthalocyanine green, carbon black, titanium black, indium doped tin oxide, and antimony doped tin oxide.

20. The coating composition as claimed in claim 19 further comprises a silane coupling agent to improve water resistance and adhesion.
